(19) United States
(12) Patent Application Publication
(10) Pub. No.: US 2003/0230085 A1
(43) Pub. Date: Dec. 18, 2003

(54) Exhaust gas turbocharger, supercharged internal combustion engine and method of operation

(76) Inventors: Siegfried Sumser, Stuttgart (DE); Peter Fledersbacher, Stuttgart (DE); Helmut Daudel, Schorndorf (DE); Helmut Finger, Leinfelden-Echterdingen (DE); Friedrich Wirbeleit, Esslingen (DE); Werner Bender, Worms (DE)

Correspondence Address: KLAUS J. BACH & ASSOCIATES, PATENTS AND TRADEMARKS, 4407 TWIN OAKS DRIVE, MURRYSVILLE, PA, 15668, US

(21) Appl. No.: 10/401,273

(22) Filed: Mar. 27, 2003

Related U.S. Application Data
(63) Continuation-in-part of application No. PCT/EP01/10525, filed on Sep. 12, 2001.

(30) Foreign Application Priority Data
Sep. 29, 2000 (DE) 100 48 237.6

(51) Int. Cl. F02D 23/00

(52) U.S. Cl. 60/602

(57) ABSTRACT

In an internal combustion engine which is provided with exhaust gas re-circulation and an exhaust gas turbocharger with an exhaust gas turbine having variable turbine geometry, and wherein the exhaust gas turbine includes two separate inflow ducts, which are separated in a pressure-tight fashion, one inflow duct communicates with an exhaust gas duct from which a re-circulation line of the exhaust gas re-circulation system extends to an intake duct.

This is a Continuation-In-Part application of International application PCT/EP01/10525 filed Sep. 12, 2001 and claiming the Priority of German application No. 100 48 237.6 filed Sep. 29, 2000.

### BACKGROUND OF THE INVENTION

The invention relates to an exhaust gas turbocharger, a supercharged internal combustion engine and a method of operating an internal combustion engine with a supercharged internal combustion engine.

The publication DE 197 34 494 C1 discloses a supercharged internal combustion engine whose exhaust gas turbocharger has an exhaust gas turbine with a variable turbine geometry (variable inlet vane structure). By adjusting the variable turbine geometry it is possible to change the effective inlet flow cross section in the turbine to the turbine wheel, as a result of which the back-pressure of the exhaust gas in the line section between the cylinder outlet of the internal combustion engine and the inlet of the turbine can be selectively influenced, whereby the power of the turbine and correspondingly the compressor power output can be adjusted. In order to improve the exhaust gas behavior of the internal combustion engine, in particular to reduce NOₓ, an exhaust gas re-circulation device for returning exhaust gas out of the exhaust gas section to the intake duct is provided. The level of the exhaust gas feed-back mass flow is adjusted as a function of state variables and operating parameters of the internal combustion engine.

If single-flow turbines with variable turbine geometry are used in such supercharged internal combustion engines with exhaust gas re-circulation, the pressure gradient with respect to the fresh air which is necessary to re-circulate the required quantity of exhaust gas is achieved by backing up the entire exhaust gas mass flow. However, as the re-circulation mass flow rate increases, the charge exchange in the cylinders is adversely affected and the fuel consumption is increased.

It is the object of the present invention to reduce the emission of pollutants and the consumption of fuel in supercharged internal combustion engines with exhaust gas re-circulation.

### SUMMARY OF THE INVENTION

In an internal combustion engine which is provided with exhaust gas re-circulation and has an exhaust gas turbocharger with variable turbine geometry, and wherein the exhaust gas turbine includes two separate inflow ducts, which are separated in a pressure-tight fashion, one inflow duct communicates with an exhaust gas duct from which a re-circulation line of the exhaust gas re-circulation system extends to an intake duct.

With this arrangement of the exhaust gas turbocharger two independent exhaust gas lines are provided between the cylinder outlets of the internal combustion engine and the exhaust gas turbine, and each inflow duct is supplied separately with exhaust gas. With such an exhaust gas turbocharger each exhaust gas line of the internal combustion engine carries the exhaust gas of some of the cylinders of the engine, and only one of the two exhaust gas lines is connected to the intake duct via a re-circulation line of the exhaust gas re-circulation device. Only the part of the engine exhaust gas of this exhaust gas line which provides for the necessary quantity of exhaust gas re-circulation is heavily backed up, as a result of which significantly smaller charge change disadvantages can be expected during the exhaust gas feedback mode, and a correspondingly lower fuel consumption can be achieved and the exhaust gas behavior can be positively influenced. The exhaust gas from a specific number of cylinders of the internal combustion engine, in particular a relatively small number of cylinders—possibly of only one cylinder—is fed to the exhaust gas line from which the exhaust gas re-circulation line branches off.

Because of the two inflow ducts which are separated from one another in a pressure-tight fashion in the exhaust gas turbine, the exhaust gas back-pressure can expediently be manipulated in that exhaust gas line or that inflow duct of the turbine which does not communicate with the exhaust gas recirculation device by means of the variable turbine geometry which is advantageously arranged in the flow inlet cross section of this inflow duct. By adjusting the variable turbine geometry, the turbine power and thus also the work to be performed by the compressor and the conveyed quantity of air are influenced in such a way that a pressure gradient which permits exhaust gas re-circulation is generated between the exhaust gas line involved in the exhaust gas re-circulation and the duc. It is, in particular, possible in the power mode of the internal combustion engine to move the variable turbine geometry of the second inflow duct of the turbine which is not involved in the exhaust gas re-circulation toward its open position, in which the turbine geometry forms only a small flow resistance in the inlet flow cross section so that the exhaust gas back-pressure is reduced in this inflow duct and less compressor work is performed and correspondingly a lower boost pressure is generated, which corresponds to the optimum air ratio. Independently of the exhaust gas back-pressure in the exhaust gas line which communicates with the inflow duct which is not involved in the exhaust gas re-circulation, it is possible to generate, in the parallel exhaust gas line from which the feedback line of the exhaust gas feedback branches off, a higher exhaust gas back-pressure, which exceeds the boost pressure on the intake side, in order to re-circulate exhaust gas into the intake duct.

While the back-up for the exhaust gas re-circulation is carried out with the first line which leads to the turbine, the desired turbine rotational speed is adjusted by way of the second duct which leads to the variable turbine geometry inlet.

The increased exhaust gas back-pressure in the first exhaust gas line which communicates with the exhaust gas recirculation line can be supported by arranging a variable or invariable flow impediment in the form of a guide vane structure or a similar design in the flow inlet cross section which is disposed in the inflow duct to which the first exhaust gas line is connected. It may be expedient also to provide in addition, or as an alternative, a variable turbine geometry vane structure in this flow inlet cross section.

Preferably, a combination turbine with a semi-axial and a radial flow inlet cross section is selected, the variable turbine geometry being expediently arranged in the radial flow inlet passage and the exhaust gas feedback being arranged in the semi-axial flow inlet passage. In contrast to combination turbines, which are known from the prior art, combination turbines with a semi-axial inlet flow path and a radial inlet flow paths are merely modified in such a way that the inlet passages are separated from one another in a pressure-tight fashion in order to prevent an undesired pressure equalization between these inlet passages. This is achieved, for example, in that a flow ring, which is arranged between the semi-axial flow passage and the radial flow passage is connected in a pressure-tight fashion to a dividing wall between the inlet passages.

In a preferred embodiment of the internal combustion engine, a bypass line which connects the two exhaust gas lines outside the exhaust gas turbine and which is equipped with an adjustable bypass valve is provided. Depending on the position of the bypass valve, a pressure equalization may be permitted between the two exhaust gas lines in order to provide, in particular in an engine mode without exhaust gas re-circulation, identical pressure conditions in both inflow ducts of the turbine. However, the bypass valve can advantageously also be switched into a position in which exhaust gas is conducted out of the exhaust gas line of one of the two exhaust gas lines or even from both exhaust gas so as to bypass the exhaust gas turbine.

The invention will become more readily apparent from the following description thereof on the basis of the accompanying drawings:

### BRIEF DESCRIPTION OF THE DRAWINGS

FIG. 1 shows a schematically a supercharged internal combustion engine with a double-flow combination turbine having a semi-axial inlet flow passage and radial inlet flow passage,

FIG. 2 shows a section through a combination turbine with two inflow passages which are formed separated in a pressure-tight fashion with respect to one another,

FIG. 3 shows a section through a further embodiment of a combination turbine,

FIG. 4 shows a section through a double-flow radial turbine, and

FIG. 5 shows in a diagram the profile of the exhaust gas mass throughput rate through a turbine as a function of the pressure gradient of the turbine, represented for each of the two inlet passages of the combination turbine.

### DESCRIPTION OF PREFERRED EMBODIMENTS

In the following figures, identical components are provided with identical reference symbols.

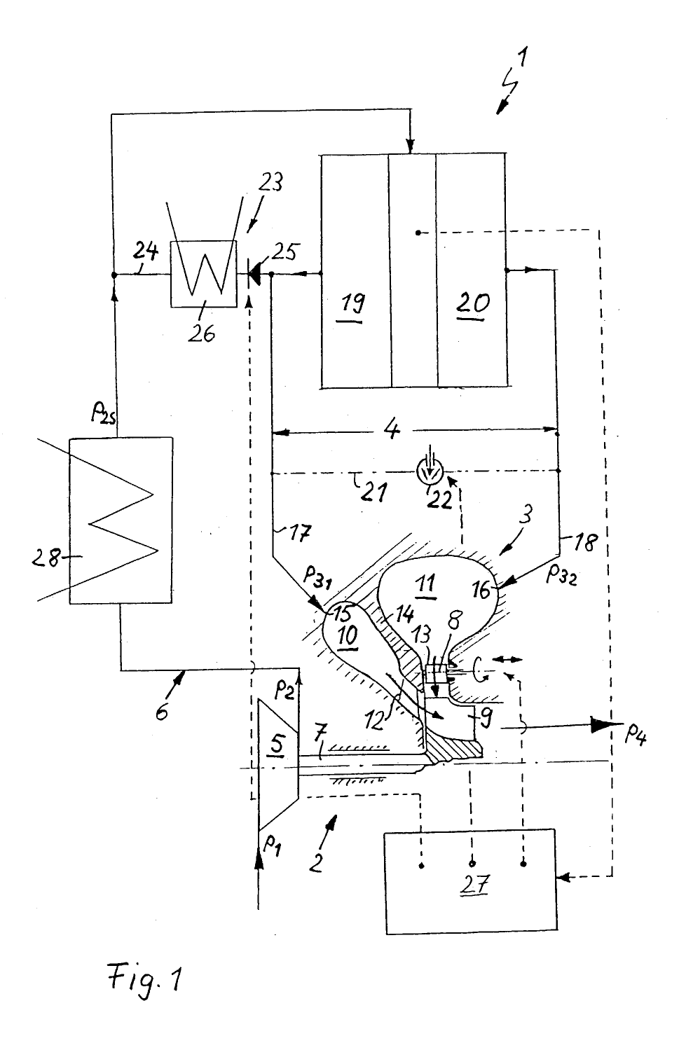

The internal combustion engine 1—that is, a spark ignition engine or a diesel engine—which is illustrated in FIG. 1 comprises an exhaust gas turbocharger 2 with a turbine 3 in the exhaust gas section 4 and with a compressor 5 in the intake tract 6, the movement of the turbine wheel being transmitted to the compressor wheel of the compressor 5 via a shaft 7. The turbine 3 of the exhaust gas turbocharger 2 is equipped with a variable turbine geometry 8, via which the effective flow inlet cross section to the turbine wheel 9 can be variably adjusted as a function of the state of the internal combustion engine. The turbine 3 is shown as a double-flow combination turbine with two inlet ducts 10 and 11, a first inlet duct 10 of which has a semi-axial inlet flow passage 12 to the turbine wheel 9 and the second inlet duct 11 has a radial inlet flow passage 13 to the turbine wheel 9. The two inflow ducts 10 and 11 are separated by a dividing wall 14 which is fixed to the housing and separates the two ducts from one another in a pressure-tight fashion.

The variable turbine geometry or vane structure 8 is expediently located in the radial inlet flow passage 13 of the inflow duct 11 and is embodied in particular as a guide vane ring with adjustable guide vanes or as a guide vane ring which can be displaced axially into the radial inlet flow passage 13. A variably adjustable inlet flow cross section is provided to the turbine wheel 9 as a function of the position of the guide vane structure.

Each inflow duct 10 or 11 is provided with an inflow port 15 or 16. Exhaust gas can be fed separately to the assigned inflow duct 10 or 11 via each inflow port 15 or 16. The exhaust gas is fed in via two exhaust gas lines 17 and 18 which are formed independently of one another and which are a component of the exhaust gas section 4. Each exhaust gas line 17 or 18 is assigned to a defined number of cylinder outlets of the internal combustion engine. In the exemplary embodiment, the internal combustion engine is a V-engine, which has two banks 19 and 20 of cylinders, each with the same number of cylinders. The first exhaust gas line 17 leads from the bank 19 of cylinders to the first inflow duct 10, and the second exhaust gas line 18 correspondingly leads from the second bank 20 of cylinders to the second inflow duct 11. A connecting bypass line 21 with an adjustable blow-off or bypass valve 22 is arranged between the two exhaust gas lines 17 and 18 upstream of the turbine 3. The bypass valve 22 can be moved into a closed position in which the bypass line 21 is closed and an exchange of pressure between the exhaust gas lines 17 and 18 is prevented, into a passage position in which the bypass line is opened, and an exchange of pressure is made possible, and into a blow-off position, in which exhaust gas is conducted out of the exhaust gas section from one of the two exhaust gas lines or from both exhaust gas lines so as to bypass the turbine.

Furthermore, an exhaust gas re-circulation device 23 is provided which comprises a re-circulation line 24 between the first exhaust gas line 17 and the intake duct 6 directly upstream of the cylinder inlet of the internal combustion engine 1, and a shut-off valve 25 or non-return valve or butterfly valve, which can be adjusted between a closed position, which blocks the exhaust gas re-circulation line 24 and an open position which opens it. An exhaust gas cooler 26 is also advantageously arranged in the exhaust gas re-circulation line 24.

All the actuating elements of the various adjustable components, in particular the variable turbine geometry 8, the bypass valve 22 and the shut-off valve 25 are adjusted to their desired positions by means of actuation signals which are generated in a control unit 27.

While the internal combustion engine is operating, the turbine power is transmitted to the compressor 5, which sucks in ambient air with the pressure p₁ and compresses it to an increased pressure p₂. A boost air cooler 28 through which the compressed air flows is arranged downstream of the compressor 5 in the exhaust gas section 6. The air leaving the boost air cooler 28 has a boost pressure p_{2S} with which it is introduced into the cylinder inlet of the internal combustion engine. At the cylinder outlet the exhaust gas back-pressure p₃₁ prevails in the first exhaust gas line 17 which is connected to the first bank 19 of cylinders, and the exhaust gas back-pressure p₃₂ is present in the second exhaust gas line 18, which is connected to the second bank 20 of cylinders. In the turbine 3, the exhaust gas pressure drops to the low pressure p₄, and in the further course the exhaust gas is firstly subjected to catalytic cleaning and subsequently discharged to the surroundings.

During exhaust gas re-circulation in the engine power mode, the shut-off valve 25 of the exhaust gas re-circulation device 23 is opened so that exhaust gas can flow from the first exhaust gas line 17 into the intake duct 6. In order to ensure a pressure gradient which permits the exhaust gas recirculation with an exhaust gas back-pressure p₃₁ in the exhaust gas line 17 which exceeds the boost pressure p_{2S}, the variable turbine geometry 8 in the radial inlet flow passage 13 of the second flow duct 11 is moved into a position, in which a pressure gradient which permits the exhaust gas feedback recirculation is established between the first exhaust gas line 17 and the intake duct 6. Such a pressure gradient is obtained taking into account the required fuel/air ratio, in particular with an open position of the variable turbine geometry 8.

Such a pressure gradient can be obtained because the first inlet flow passage 12 in the first inflow duct 10 is relatively small and assumes a value which is preferably slightly greater than the second inlet flow passage 13 in the back-pressure position of the variable turbine geometry, but is smaller than this cross section in the open position of the variable turbine geometry. Because of the relatively small first inlet flow passage cross section 12, a relatively high exhaust gas back-pressure p₃₁ can be generated in the first exhaust gas line 17. When the exhaust gas re-circulation is active, in particular the exhaust gas back-pressure p₃₁ in the first exhaust gas line 17 is higher than the exhaust gasback-pressure p₃₂ in the second exhaust gas line 18, which is not connected to the exhaust gas re-circulation device 23.

In the engine braking mode, the variable turbine geometry is moved into its back-pressure position in which the radial flow inlet passage cross section 13 is reduced to a minimum value, as a result of which the exhaust gas back-pressure p₃₂ in the second exhaust gas line 18 rises to a high value, which is in particular greater than the exhaust gas back-pressure p₃₁ in the first exhaust gas line 17 which communicates with the exhaust gas re-circulation device 23. As a result, it is possible to achieve a very high engine braking power by strongly raising the exhaust gas back-pressure p₃₂ without exceeding the critical rotational speed limit of the exhaust gas turbocharger because the valves 22 and 25 are advantageously activated.

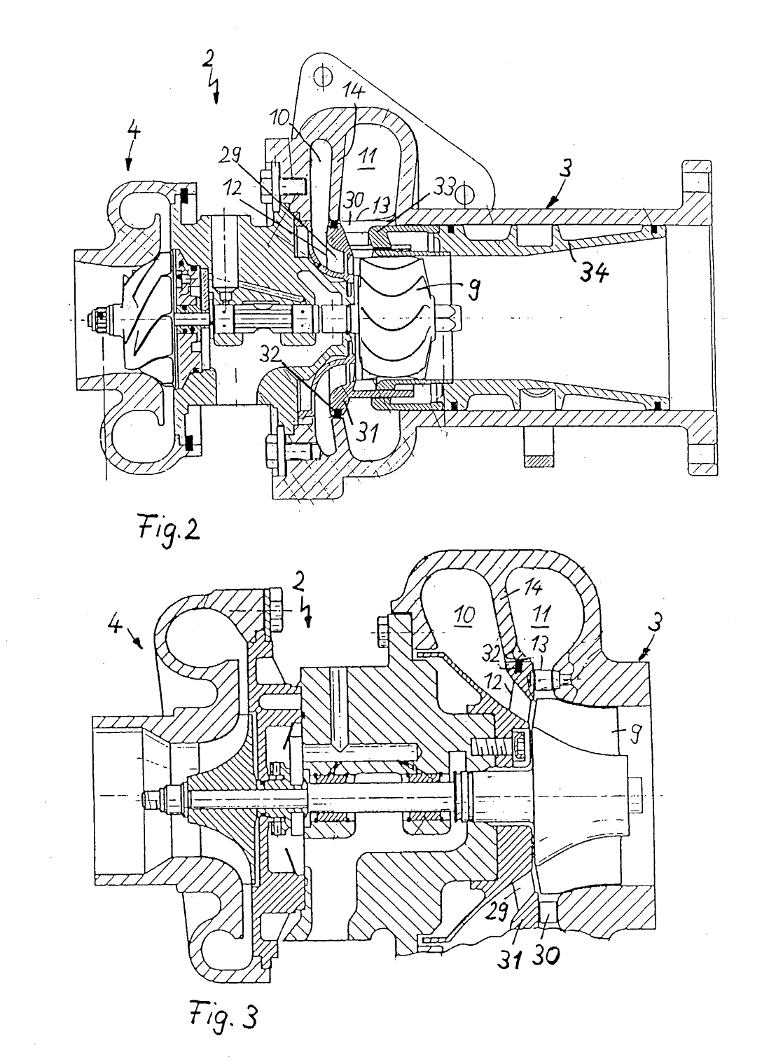

In the sectional view according to FIG. 2, an exhaust gas turbocharger 2 is shown with an exhaust gas turbine 3 with variable turbine geometry 8. The turbine 3 comprises a first inflow duct 10 with semi-axial inlet flow passages 12 and a second inflow duct 11 with radial inlet flow passages 13. Exhaust gas can be fed to the turbine wheel 9 from the inflow ducts 10 and 11 via the inlet flow passages 12 and 13. In the semi-axial inlet flow passages 12, there is a fixed vane structure 29, whereas in the radial inlet flow passages 13 there is arranged, in addition to a guide vane structure 30, a guide ring 33 which can be moved axially into the flow inlet passages 13. The two inflow ducts 10 and 11 are separated by means of a dividing wall 14 which is fixed to turbine the housing. In the region of the inlet flow passages 12 and 13 there is arranged a flow ring 31 which divides the two inlet flow passages, is contoured in a fluidically advantageous way and whose radial outer side faces the end region of the dividing wall 14, which is turned radially inward. An annular sealing element 32 is arranged between the end side of the dividing wall 14 and the radially outer side of the flow ring 31 to provide pressure-tight guidance between the inflow ducts 10 and 11.

The axially displaceable guide structure 33 in the radial inlet flow passage 13 is attached to an axial slide 34 which surrounds the turbine wheel 9 in an annular fashion. The rigid guide vane structure, which extends into the moveable guide structure is attached to the flow ring 31 in the example shown.

The first inflow duct 10, which opens to the semi-axial flow inlet passage 12, has a considerably smaller cross-section than the second inflow duct 11 with the radial flow inlet passage 13.

The turbine 3 of the exhaust gas turbocharger 2 according to FIG. 3 also has a first inflow duct 10 with a semi-axial inlet flow passage 12 and a second inflow duct 11 with a radial inlet flow passage 13, which are separated by means of a dividing wall 14, the two flow inlet passages 12 and 13 are bounded directly by the flow ring 13 and a sealing element 32 being provided between the flow ring 31 and dividing wall 14. The vane structure in the semi-axial flow inlet passage 12 is a fixed guide vane structure 29, while an adjustable flow guide structure 30 with adjustable guide vanes is arranged in the radial inlet flow passage 13. In the exemplary embodiment according to FIG. 3, the volumes of the inflow ducts 10 and 11 are approximately the same.

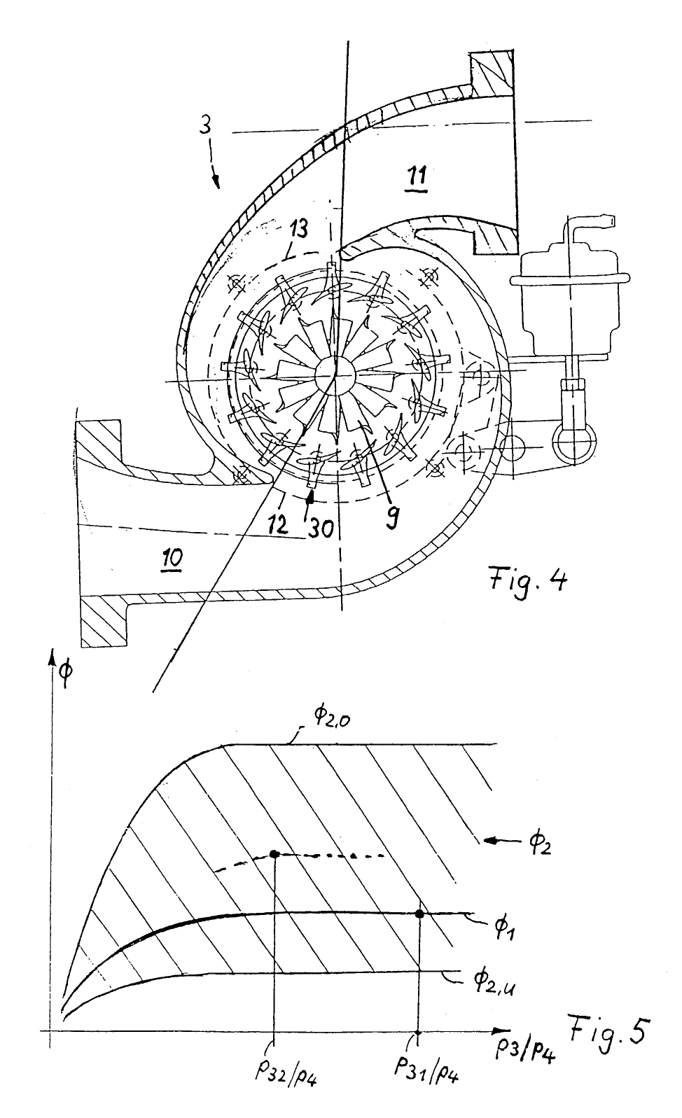

The sectional view according to FIG. 4 shows a radial turbine with two radial inflow ducts 10 and 11. The inflow ducts 10 and 11 of the turbine 3, which is also referred to as a dual-segment turbine, are in the shape of partial spirals and are open, at radially opposite ends via their inlet flow passages 12 and 13, into the turbine chamber, which holds the turbine wheel 9. It may be expedient to provide an angle of the opening cross sections of the inflow ducts to the turbine wheel 9, which is different from 180°. The flow guide vane structure 30, which surrounds the turbine wheel 9 radially, has adjustable guide vanes.

FIG. 5 shows the profile of the turbine throughput rate parameter φ as a function of the pressure gradient p₃/p₄ over the gas turbine, p₃ designating the exhaust gas back-pressure upstream of the turbine, and p₄ the relaxed pressure downstream of the turbine. On the one hand, the throughput rate parameter φ₁ for the first flow duct is illustrated; the throughput rate parameter φ₁ is represented as a line because of the fixed vanes in the inlet flow passages assigned to the first inflow duct. The throughput rate parameter φ₂, which is represented in the second inflow duct, is shown as a hatched area. Because of the variably adjustable turbine vanes with a variable inlet flow passages, the lower limit φ_{2,U} of this area corresponds to the closed position of the variable turbine geometry and its upper limit φ_{2,O} corresponding to the open position of the turbine geometry. A dashed line in the adjustment range of the variable turbine geometry shows, by way of example, an instantaneous guide vane position at which a high exhaust gas back-pressure p₃₁, which favors exhaust gas re-circulation, occurs in the first inflow duct because of the comparatively small inlet flow cross section in the first flow duct with fixed cascade and the resulting high back-up capability in this inflow duct. In contrast, in the second inflow passage with variable turbine geometry, a lower exhaust gas back-pressure p₃₂ is generated, as a result of which the turbine can be operated in more favorable efficiency ranges.

What is claimed is:

1. An internal combustion engine including air intake and exhaust ducts, an exhaust gas turbocharger with turbine and compressor wheels and an exhaust gas re-circulation device, having the following features:
the exhaust gas turbocharger (2) comprises an exhaust gas turbine (3) equipped with a variable turbine geometry (8), in an exhaust structure (4), and a compressor (5) in the intake duct (6), the variable turbine geometry (8) being adjustable between a back-pressure position and an open position,
the exhaust gas turbine (3) is a double-flow turbine with two separate inflow ducts (10, which are of different sizes and which each have one inlet flow passage (12, 13) to the turbine wheel (9),
the exhaust gas re-circulation device (23) comprises a recirculation line (24) extending between the exhaust gas duct (17) and intake duct (6) and an adjustable shut-off valve (25),
the exhaust gas structure (4) includes two separate exhaust ducts (17, 18) each connecting some of the cylinders of the internal combustion engine (1) to one of the inflow ducts (10, 11) of the exhaust gas turbine (3), the recirculation line (24) of the exhaust gas re-circulation device (23) extends to the intake duct (6) the particular exhaust gas line (17), which communicates with the smaller of the two inflow ducts (10,11),
the variable turbine geometry (8) is arranged in the inlet flow passage (13) of the second flow duct (11), which is not in communication with the exhaust gas re-circulation line (24),
a control unit (27) is provided by which actuation signals for adjusting the variable turbine geometry (8) and the shut-off valve (25) are generated as a function of the state of the internal combustion engine (1),
the two inflow ducts (10,11) are separated from one another in a pressure-tight fashion, and
the first inlet flow passage (12) in the first inflow duct (10) has a cross-section which is greater than the second inlet flow passage cross-section (13), which is part of the second inflow duct (11), but, in the back-pressure position of the variable turbine geometry (8), is smaller than the cross-section of the second inlet flow passage (13) in the open position of the variable turbine geometry (8)

2. The internal combustion engine according to claim 1, wherein the first exhaust gas line (17), which communicates with the feedback line (24), is connected to a smaller number of cylinder outlets than the second exhaust gas line (18).

3. The internal combustion engine according to claim 1, wherein the flow cross-section of the inlet flow passage (12) which is part of the first inflow duct (10) is small in comparison with the flow cross-section of the inlet flow passage (13) which is part of the second inflow duct (11), said inlet flow cross section (12) being reducible to zero.

4. The internal combustion engine according to claim 1, wherein the two exhaust ducts (17, 18) are interconnected by a by-pass line (21) which is provided with an adjustable bypass valve (22).

5. The internal combustion engine according to claim 1, wherein the variable turbine geometry (8) is arranged in the inlet flow passage (13) of the second flow duct (11), which is not in communication with the exhaust gas re-circulation line (24).

6. The internal combustion engine according to claim 4, wherein the bypass line (21) which interconnects the two exhaust ducts (17, 18) is provided with an adjustable bypass valve (22).

7. An exhaust gas turbocharger for an internal combustion engine, having an exhaust gas turbine (3) with a turbine wheel (9) and a compressor (5), which is connected to the exhaust gas turbine (3) via a shaft (7), the exhaust gas turbine )3) being a double-flow turbine with two inflow ducts (10, 11) each with an inlet flow passage (12, 13) leading to the turbine wheel (9), a variable turbine geometry (8) for variably adjusting the flow cross-section of at least one of the flow inlet passages (12, 13), wherein the two inflow ducts (10, 11) are separated from one another in a pressure-tight fashion and each has an inflow port (15, 16) for the separate feeding-in of exhaust gas.

8. The exhaust gas turbocharger as claimed in claim 7, wherein the exhaust gas turbine (3) is a combination turbine and a first of the inflow duct (10) has a semi-axial inlet flow passage (12) leading to the turbine wheel (9), and the second inflow duct (11) has a radial inlet flow passage (13).

9. The exhaust gas turbocharger according to claim 8, wherein the variable turbine geometry (8) is arranged in the radial inlet flow passage (13).

10. The exhaust gas turbocharger as claimed in claim 8, wherein the two inflow ducts (10, 11) are separated by a dividing wall (14) in the housing of the exhaust turbine (3).

11. The exhaust gas turbocharger according to claim 10, wherein a flow ring (31) is provided between the flow inlet passages (12, 13) of the two inflow ducts (10, 11) and a sealing element (32) is provided between the flow ring (31) and dividing wall (14).

12. The exhaust gas turbocharger according to claim 7, wherein the variable turbine geometry (8) is a guide vane structure (30) with adjustable guide vanes.

13. The exhaust gas turbocharger according to claim 7,, wherein the variable turbine geometry (8) is a guide vane ring (30) which axially movable into the inlet flow passage.

14. A method for operating an internal combustion engine including an exhaust gas turbine (3) with a turbine wheel (9) and a compressor (5), which is connected to the exhaust gas turbine (3) via a shaft (7), the exhaust gas turbine )3) being a double-flow turbine with two inflow ducts (10, 11) each with an inlet flow passage (12, 13) leading to the turbine wheel (9), a variable turbine geometry (8) for variably adjusting the flow cross-section of at least one of the flow inlet passages (12, 13), wherein the two inflow ducts (10, 11) are separated from one another in a pressure-tight fashion and each has an inflow port (15, 16) for the separate feeding-in of exhaust gas, said method comprising the steps of:
in the power mode, re-circulating exhaust gas from the exhaust gas duct (17), which is connected to the first inflow duct (10), back into the intake duct (6), and
in an engine braking mode, preventing exhaust gas re-circulation and moving the variable turbine geometry (8) in the second flow duct (11) into a back-pressure position, which increases the back-pressure of the exhaust gas.

15. The method according to claim 14, wherein, in the engine braking mode, the exhaust gas ducts (17 and 18) are inter connected by opening the bypass valve (22) and turbine rotational speed is controlled discharging exhaust gas via the bypass valve (22) which also is a discharge valve (22).
